(19) United States
(12) Patent Application Publication
(10) Pub. No.: US 2012/0293000 A1
(43) Pub. Date: Nov. 22, 2012

(54) System and method for supplementing a generated DC power supply

(75) Inventors: Jerry Fan, Birmingham, AL (US); Scott Allen Hill, Scottsdale, AZ (US); Jianchu Zheng, Shanghai (CN); John Robert Berkheimer, Scottsdale, AZ (US)

(73) Assignee: Jerry Fan, Birmingham, AL (US)

(21) Appl. No.: 13/296,056

(22) Filed: Nov. 14, 2011

Related U.S. Application Data
(60) Provisional application No. 61/413,414, filed on Nov. 13, 2010.

(51) Int. Cl. H02J 1/10

(52) U.S. Cl. 307/64

(57) ABSTRACT

Renewable energy farmed from solar, wind or the like enters a DC to DC converter with pulse width modulation (PWM) control to produce a generated DC with a known voltage. A micro controller controls the PWM control of the generated DC between zero and 100 percent such that it is suitable for a particular DC load. If the PWM is at 100%, then the MCU switches on power from an AC to DC converter with ON/OFF control for producing a line DC. The line DC is combined with the generated DC to supplement the generated DC so the load performs reliably. Alternatively, several capacitors in parallel are used to allow the generated DC to charge at least two of the capacitors, while a third capacitor that is charged from grid AC is always ready to be used as a backup source of power.

This application claims the benefit of priority of U.S. Provisional Application No. 61/413,414, filed on Nov. 13, 2010, and titled “System and method for supplementing a generated DC power supply”, incorporated herein by reference in its entirety.

### BACKGROUND OF THE INVENTION

Peak electrical power use by most businesses and homes is during daylight hours, especially during summer months when air conditioning use is highest. Geographical regions that are sunny are ideal for solar energy collection, such as with photovoltaic cells. Typically, solar energy collection is used to either charge a primary power source, such as battery storage for powering lights at night, or collected solar energy is converted into AC that is fed into an existing system that is primarily supplied with grid power. Some devices, such as toy pool fountains and animated garden decorations, operate only when the sun is adequately shinning directly onto small solar cells that power the toy.

There is a need to maximize the use of available renewable power, such as wind or solar DC power, without requiring expensive and heavy batteries that have a relatively short life, but also without sacrificing the availability or reliability of a device that is powered by a renewable energy source.

### SUMMARY OF THE INVENTION

The present invention is an electrical circuit and computer program system for delivering power from a renewable energy source to a nearby device that preferably and primarily uses power provided by the renewable source. In the preferred embodiment, circuitry of the system allows grid power to supplement the device when the renewable power output does not adequately meet the immediate demands of the device. The circuitry continues to maximize use of the renewable energy until the output is sufficient to operate the device independently. In the preferred embodiment, the load is a permanent magnet motor that rotates a fan and the renewable energy is a solar DC supply. Because the demand for air movement is typically highest when the sun is high and bright, application of the present invention in an evaporative cooling system would be useful.

### BRIEF DESCRIPTION OF THE DRAWINGS

FIG. 1 is a diagram showing the main components and circuit paths of the preferred embodiment of the present invention.

FIG. 2 is a flow chart of computer logic used by an MPU of the system in FIG. 1.

FIG. 3 is a diagram showing the main components and circuit paths of an alternate preferred embodiment of the present invention.

FIG. 4 is a flow chart of computer logic used by the MPU shown in FIG. 3.

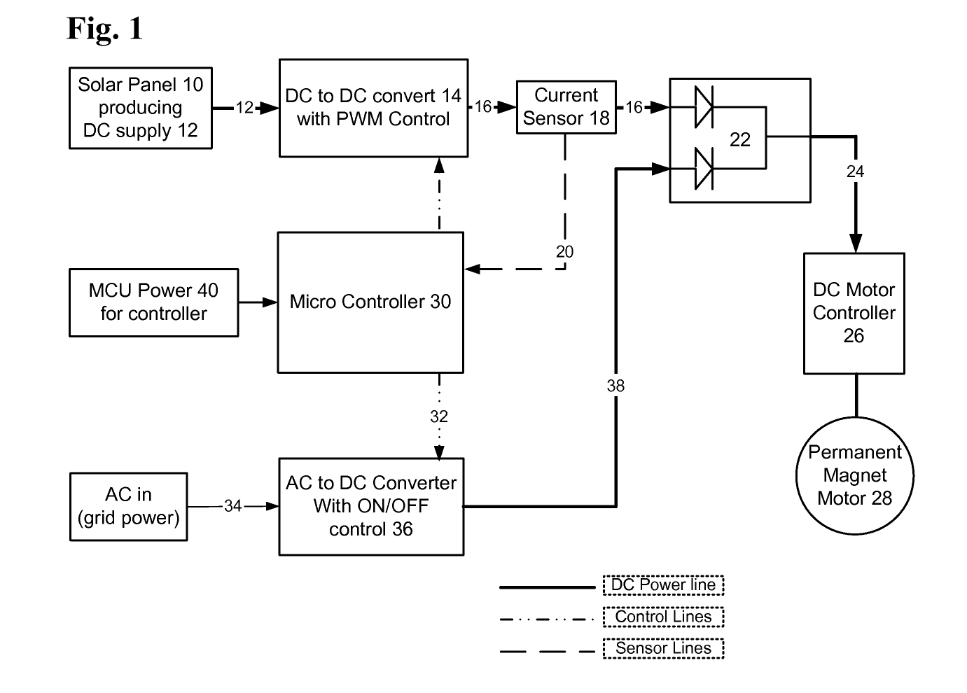

The following is the list of numerical callouts used in FIGS. 1-4:
10 solar panel array
12 DC supply
14 DC to DC converter
16 solar DC
18 current sensor
20 sensor line
22 diodes
24 combined DC
26 DC motor controller
28 permanent magnet motor
30 micro controller (MCU)
32 control line
34 AC supply
36 AC to DC converter
38 line DC
40 MCU Power

### DETAILED DESCRIPTION OF THE INVENTION

This detailed description will describe an electrical system and method for reliably powering a device using a renewable energy source, such as a solar DC supply. preferably, an electrical circuit of the present invention has a renewable DC supply 12 that is converted into a desired DC voltage 16 that is delivered to a DC motor controller 26 of a permanent magnet motor 28. A micro controller 30 of the system monitors the amount of supplied solar DC 16 having the desired DC voltage. If the maximum power available from solar panels 10 at a given instant is not adequate to power the motor of the system, then the micro controller turns on line DC 38, which is produced from an AC supply 34 that has gone through an AC to DC converter 36, to supplement the solar DC 16. The micro controller continuously monitors and adjusts the amount of line DC delivered, completely shutting it off when not needed. Additional features, such as diodes, voltage monitors, displays and surge protectors, will be discussed. Where reference numbers in one figure are the same as another figure, those reference numbers carry substantially the same meaning. Preferred components, steps, uses and configurations will be discussed, but these preferences are not intended to exclude other suitable or functionally equivalent components, steps, uses and configurations.

Renewable energy is most cost effectively produced by harnessing wind or solar, but other known resources could be substituted to attain similar results using the circuitry and logic of the present invention. By way of example, but not limitation, in FIG. 1 an array of solar panels 10 is used to generate “solar DC” 16, a term we will use throughout this description. The size and arrangement of solar panels is not particularly important so long as the generated solar DC adequately meets the needs of a device. Preferably, the amount of solar DC available at peak solar panel output in the summer is at least adequate to fully power the device without being supplemented by grid power, which we will call “line DC” 38 throughout this description. A typical system will produce more power than needed for a portion of many summer days. Whether solar panels track the sun or otherwise are positioned to improve power generation is an important consideration that we will not address. For the present example, we will assume that a fixed array of four 125 watt solar panels is mounted to a roof, so the maximum rated output will be 500 watts, and we will assume a DC output of the array that is between about 5 and 15 volts. A surge protector can be added to protect the DC to DC converter.

The DC supply, shown in FIG. 1, is delivered to a DC to DC converter 14 characterized by pulse width modulation control, or PWM control. In the example we are creating, the device could be a ½ horsepower rated permanent magnet motor 28 with a maximum 180 volt input. The DC to DC converter for such a device should be a step-up (boost) regulator with PWM control.

A current sensor 18 detects how much solar DC 16 is supplied at the desired voltage by the solar panels. The current sensor value is input into a micro controller 30, and the solar DC passes through an optional diode 22 before finally being delivered to a DC motor controller 26 of the permanent magnet motor 28. The coils of the motor are the inductive load.

When there is not enough solar DC 16 to start or maintain a desired motor speed, the micro controller (MCU) 30 detects the amount of solar DC at the current sensor and starts to supplement the total current with line DC 38. The solar DC and line DC are joined after they have gone through diodes 22 that prevent the backflow of current into the weaker source. Once the two currents (16 and 38) are joined, the combined currents feed the motor in the same way as already described.

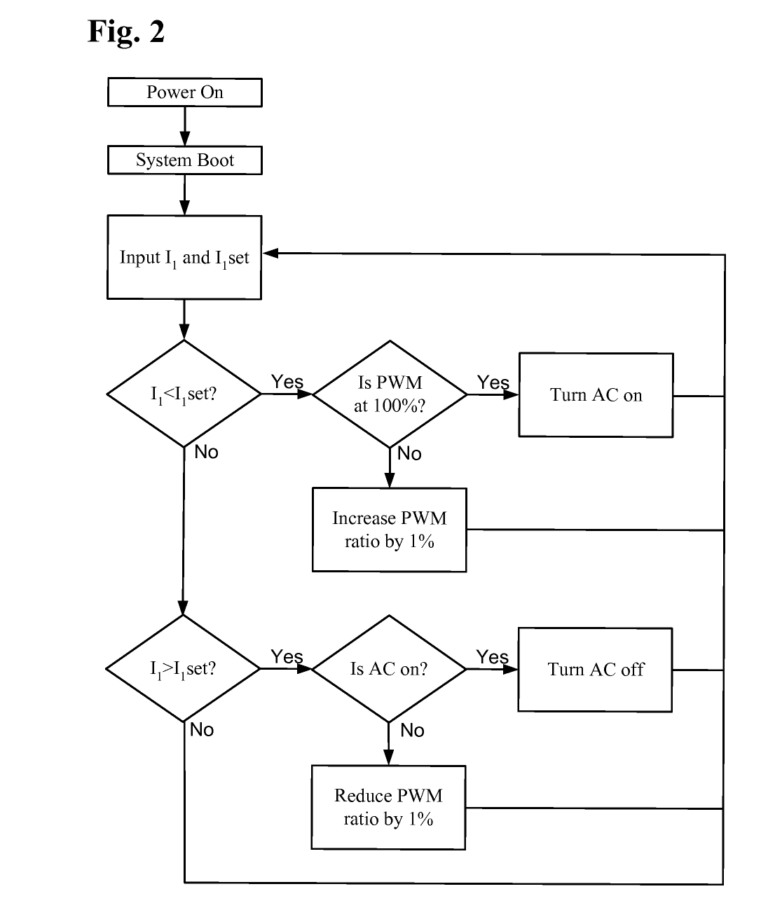

FIG. 2 shows the logic that is used by the MCU 30, such as a common 8 bit controller. Any suitable user interface can be combined with the present invention, from a simple wall switch to a programmable climate control panel. Once the power is turned on, the system boots and the MCU acquires a value from the current sensor 18 (from FIG. 1) that tells the program how much solar DC 16 is being produced by the solar panels 10. The computer logic compares the solar DC current, I1, to a defined maximum current, I1set. If there is too little solar DC current, then the MCU increases the PWM ratio of the boost regulator a little bit, such as one percent, and then the program compares the current values again. If the PWM control reaches 100%, then the solar DC current is not adequate to meet the demands of the motor, so the program adds line DC 38 by turning the AC on. One way to increase line DC is by using a PWM control in the MCU that controls a FET switch that is on an AC to DC converter. If there is too much power, the MCU turns the AC off, thereby decreasing how much line DC is supplied, and then the MCU starts decreasing how much solar DC 16 is supplied until the total supplied current 24 is equal to the desired amount.

The voltage of the AC supply 34, which is grid power, is known and very consistent, so it is not necessary to have a current sensor after the rectifier of the circuit because the current can be calculated by the MCU based on the percentage of time that the PWM control of the DC to DC converter is on. Alternatively, a PWM control can be part of the AC to DC converter, in which case it would no longer be necessary to place diodes before the DC motor controller.

The micro controller 30, or MCU, is preferably an 8 bit controller with preloaded software containing a computer program that runs the logic shown in FIG. 2. The MCU requires a nominal amount of power, MCU power 40, which can be supplied by small batteries, AC supply and/or solar DC. The main purpose of the MCU is to control the ON/OFF control of the AC to DC converter to supplement solar DC, as well as to control the DC to DC converter to prevent excess solar DC from being delivered to the motor of the system.

An optional purpose of the MCU is to calculate and display information about the system to a user. The ratio of solar DC versus line DC would be useful, both present and average over a defined time period. This type of information could let a user know whether there were any potential problems with the system. Also, the MCU can be used to control the speed of the motor, possibly even by making the MCU programmable based on time of day, temperature or other desired variables.

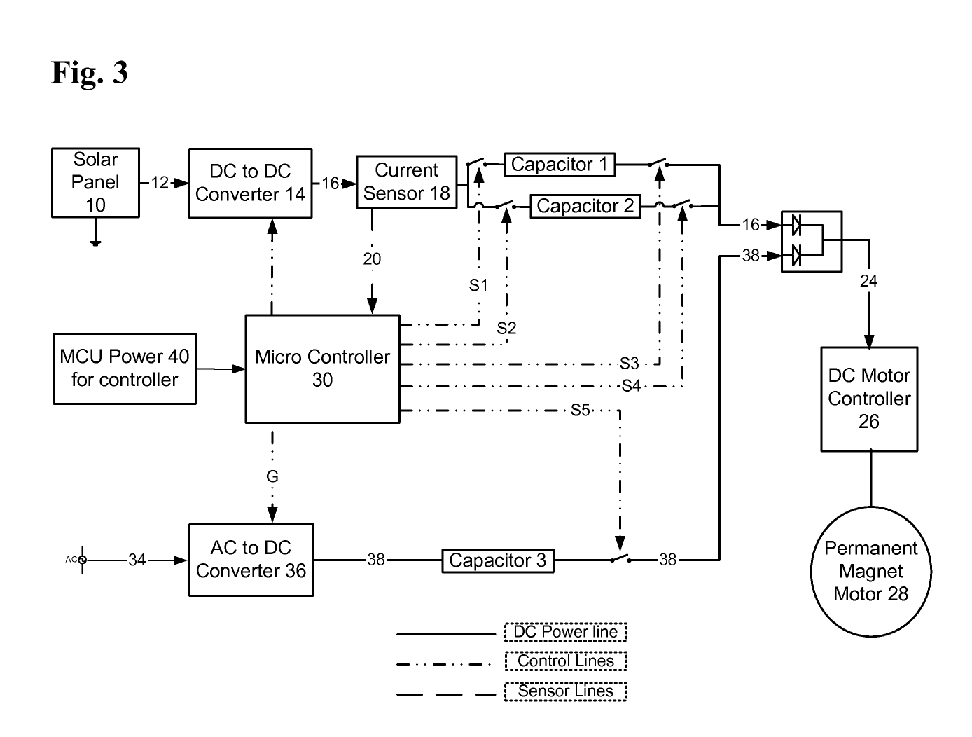

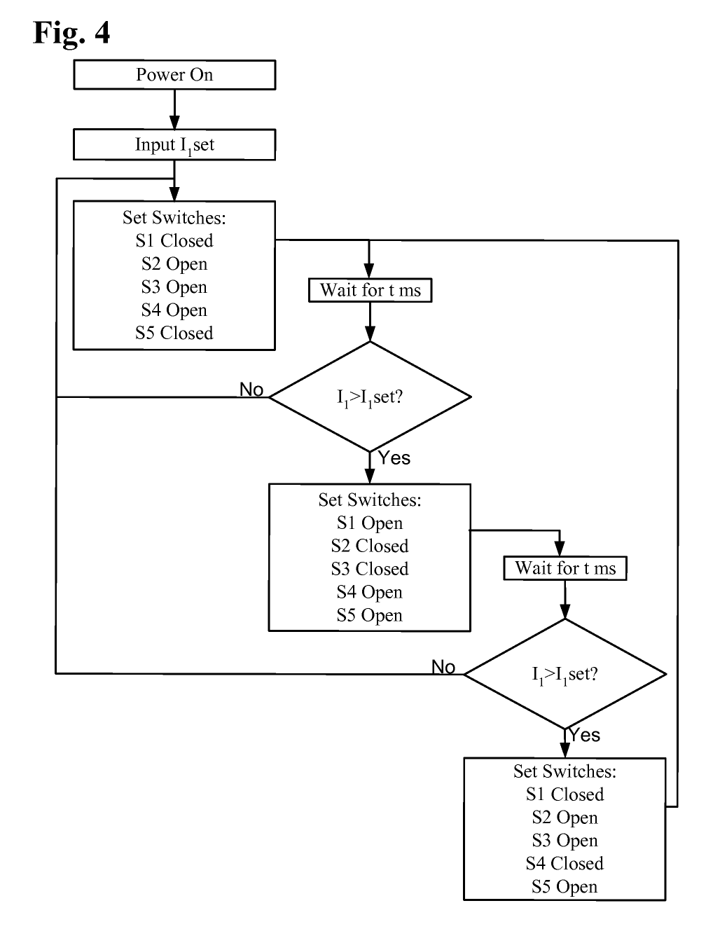

FIG. 3 shows an alternate embodiment of the present invention that does not use or need any PWM controls. The solar DC passes through a boost regulator to produce a desired voltage, and parallel switches S1 and S2 are alternately opened and closed to charge Capacitor 1 and Capacitor 2, respectively. When a current sensor located before the capacitors determines that one of the capacitors is charged, then switches S1 and S2 are operated to change which capacitor is being charged by the solar DC. Switches S3, S4 and S5 are operated to change which one of the three capacitors will be used to power a phase of the permanent magnet motor. Capacitor 3, which is charged by line DC, is always available. The length of time that one of the switches S3, S4 or S5 is closed will affect the speed of the motor, so changing the wait time t will change the speed of the motor. FIG. 4 shows computer logic that controls the above circuit.

While a preferred form of the invention has been shown and described, it will be realized that alterations and modifications may be made thereto without departing from the scope of the following claims.

What is claimed is:

1. A system for supplementing a generated renewable energy DC supply with a utility grid AC supply, comprising:
a generated DC;
a DC to DC converter with pulse width modulation (PWM) control;
a current sensor after the DC to DC converter;
a micro controller that can control the PWM control of the DC power supply between zero and 100 percent;
a DC load;
an AC supply;
an AC to DC converter with ON/OFF control for producing a line DC;
a means for combining the line DC and the generated DC;
wherein, when the PWM for the DC to DC converter is at 100%, the microcontroller can supplement power delivered to the DC load by increasing or decreasing the length of time that the AC to DC converter is ON.

2. The system of claim 1 wherein the means for combining the line DC and the generated DC is a pair of diodes connected in parallel to the DC load.

3. The system of claim 1 wherein the means for combining the line DC and the generated DC is a connector; and wherein the AC to DC converter is further characterized by a PWM control such that there is no potential difference between the line DC and the generated DC at the connector.

4. The system of claim 1 further comprising a battery backup power supply for the MCU.

5. The system of claim 1 further comprising a user display that can be used by a user to view information about the system.

6. The system of claim 5 wherein the user display is programmable by the user.

7. The system of claim 1 further comprising a current sensor along the line DC, the value of the current sensor being detected and used by the MCU.

8. A method for controlling a supplemented power supply comprising the steps of:
Inputting the value of a maximum current and a generated current into a microcontroller;
Determining whether the generated current is smaller, larger or equal to the maximum current;
If the generated current is smaller than the maximum current, then increasing a PWM ratio of the generated current, but if the PWM ratio is at 100%, then increasing a line DC percentage;
If the generated current is larger than the maximum current, then decreasing the line DC percentage, but if the line DC percentage is 0%, then decreasing the PWM ratio of the generated current;
If the generated current is equal to the maximum current, then making no changes; and
Repeating the above steps (??? After waiting t?).

10. A system for supplementing a generated renewable energy DC supply with a utility grid AC supply, comprising:
a generated DC;
a DC to DC converter;
a current sensor after the DC to DC converter;
first and second capacitors that are in parallel after the current sensor;
first and second switches located before the first and second capacitors, respectively;
third and fourth switches located after the first and second capacitors, respectively;
a DC load;
an AC supply;
an AC to DC converter for producing a line DC;
a third capacitor located along the line DC;
a fifth switch located after the third capacitor;
a micro controller that can control the first, second, third, fourth and fifth switches; and
a computer program that allows the switches to be controlled by the MCU such that power is alternately and preferentially delivered to the DC load from the first or second capacitor, but the third capacitor is selected when neither the first nor second capacitor is charged enough to deliver current to the DC load.

11. The system of claim 10 wherein the DC load is a permanent magnet motor.

12. The system of claim 10 further comprising a battery backup power supply for the MCU.

13. The system of claim 10 further comprising a user display that can be used by a user to view information about the system.

14. The system of claim 13 wherein the user display is programmable by the user.
